(19) United States
(12) Patent Application Publication
(10) Pub. No.: US 2014/0251276 A1
(43) Pub. Date: Sep. 11, 2014

(54) Piezo Injector

(71) Applicant: Willibald Schürz, Pielenhofen (DE)

(72) Inventor: Willibald Schürz, Pielenhofen (DE)

(21) Appl. No.: 14/234,039

(22) PCT Filed: Jul. 13, 2012
(86) PCT No.: PCT/EP2012/063753

§ 371 Date: May 5, 2014

(30) Foreign Application Priority Data
Jul. 20, 2011 (DE) 10 2011 079 468.9

(51) Int. Cl. F02M 51/06

(52) U.S. Cl. CPC F02M 51/0603
USPC 123/456; 239/102.2

(57) ABSTRACT

A piezo injector includes (a) an actuator chamber in which a piezo actuator is arranged, (b) a control piston bore in which a control piston having a first end side facing the piezo actuator is arranged, wherein a portion of the control piston bore delimited by the first end side forms a first control chamber and an opposing portion of the control piston bore forms a spring chamber, and wherein the control piston is arranged between the first control chamber and the spring chamber, (c) a nozzle needle having a second end side, wherein the nozzle needle guides a nozzle needle sleeve, wherein the nozzle needle sleeve and the second end side delimit a second control chamber, (d) a connecting bore between the first control chamber and second control chamber, and (e) a leakage pin arranged between the piezo actuator and the first end side in a leakage pin bore.

### CROSS-REFERENCE TO RELATED APPLICATIONS

This application is a U.S. National Stage Application of International Application No. PCT/EP2012/063753 filed Jul. 13, 2012, which designates the United States of America, and claims priority to DE Application No. 10 2011 079 468.9 filed Jul. 20, 2011, the contents of which are hereby incorporated by reference in their entirety.

### TECHNICAL FIELD

The invention relates to a piezo injector, e.g., for an internal combustion engine.

### BACKGROUND

Internal combustion engines with direct fuel injection are known. For direct fuel injection, piezo injectors are used, a nozzle needle of which is driven by means of a piezo actuator. In this case, it is necessary to have between the piezo actuator and nozzle needle virtually play-free coupling which, however, is difficult to maintain because of thermal length changes in the piezo injector. Too small an idle stroke between the piezo actuator and nozzle needle will result in incomplete closing of the nozzle needle. Too large an idle stroke between the piezo actuator and nozzle needle leads to an increase in the activation energy necessary for activating the piezo injector. In the prior art, attempts were made to compensate thermal length changes by a suitable choice of material and by the geometry. However, this results in high manufacturing costs and greatly restricts structural freedom in the configuration of the piezo injector.

### SUMMARY

One embodiment provides a piezo injector, with an actuator space in which a piezo actuator is arranged, a control piston bore in which a control piston is arranged, the control piston having a first end face confronting the piezo actuator, a portion, delimited by the first end face, of the control piston bore forming a first control space, a portion, opposite the first control space, of the control piston bore forming a spring space, the control piston being arranged between the first control space and the spring space, a nozzle needle with a second end face, the nozzle needle guiding a nozzle needle sleeve, the nozzle needle sleeve and the second end face delimiting a second control space, a connecting bore between the first control space and the second control space, and a leakage pin which is arranged between the piezo actuator and the first end face in a leakage pin bore.

In a further embodiment, a first leakage out of the first control space being made possible, a second leakage out of the spring space into the first control space being made possible, a third leakage out of a high-pressure region into the second control space being made possible, a sum of the second leakage and of the third leakage being at least as large as the first leakage, and the sum of the second leakage and of the third leakage being so small that, with the nozzle needle open, a pressure rise in the second control space brought about by the second leakage and the third leakage does not lead to closure of the nozzle needle.

In a further embodiment, the piezo injector has a high-pressure bore, the high-pressure bore being connected to the high-pressure region, and the high-pressure region being connected to the spring space.

In a further embodiment, the spring space has arranged in it a control piston spring which acts upon the control piston with a force acting in the direction of the first control space.

In a further embodiment, the piezo injector having a nozzle spring which acts upon the nozzle needle with a force directed away from the second control space.

In a further embodiment, a first pairing play is present between the leakage pin and the leakage pin bore, the first pairing play making the first leakage possible, and the first pairing play amounting to less than 2 μm.

In a further embodiment, a third pairing play is present between the nozzle needle and the nozzle needle sleeve, the third pairing play making the third leakage possible, and the third pairing play amounting to between 5 μm and 8 μm.

In a further embodiment, a second pairing play is present between the control piston and the control piston bore, the second pairing play making the second leakage possible, and the second pairing play amounting to between 5 μm and 8 μm.

In a further embodiment, the control piston having a throttle bore running between the first control space and the spring space, and the throttle bore making the second leakage possible.

In a further embodiment, the throttle bore is closed by the leakage pin when the leakage pin bears against the control piston.

In a further embodiment, a throttle is arranged in the connecting bore between the first control space and the second control space.

In a further embodiment, the piezo actuator is a fully active piezo stack.

### BRIEF DESCRIPTION OF THE DRAWINGS

Example embodiments of the invention are described below in more detail with reference to the accompanying figures in which:

FIG. 1 shows a sectional view of an upper part of a piezo injector; and

FIG. 2 shows a sectional view of a lower part of the piezo injector.

### DETAILED DESCRIPTION

Embodiments of the present invention provide a piezo injector in which length changes of the piezo injector are compensated automatically.

According to some embodiments, a piezo injector comprises an actuator space in which a piezo actuator is arranged, a control piston bore in which a control piston is arranged which has a first end face confronting the piezo actuator, a portion, delimited by the first end face, of the control piston bore forming a first control space, a portion, opposite the first control space, of the control piston bore forming a spring space, and the control piston being arranged between the first control space and the spring space, a nozzle needle with a second end face, the nozzle needle guiding a nozzle needle sleeve, the nozzle needle sleeve and the second end face delimiting a second control space, a connecting bore between the first control space and the second control space, and a leakage pin which is arranged between the piezo actuator and the first end face in a leakage pin bore. Advantageously, in this piezo injector, there is hydraulic coupling between the piezo actuator and the nozzle needle. This hydraulic coupling advantageously has the effect of play compensation and stroke step-up. Advantageously, as a result, length changes in the piezo injector which are caused by temperature effects, wear at contact points in the drive and changes in the state of polarization of the piezo actuator can be compensated. This advantageously enables the injector to be manufactured from any material, without thermal expansion properties of the material having to be taken into account. Advantageously, therefore, a material especially resistant to high pressure can be used. Advantageously, complicated processes for setting an idle stroke when the piezo injector is being mounted are dispensed with, thus reducing the manufacturing costs of the piezo injector. By an idle stroke being dispensed with, energy required for activating the piezo injector is also reduced. A further advantage of the piezo injector is improved injection quantity stability during dynamic engine operation. It is likewise advantageous that pressure losses in the piezo injector are reduced, as compared with the prior art.

It is expedient that a first leakage out of the first control space is made possible, a second leakage out of the spring space into the first control space is made possible and a third leakage out of a high-pressure region into the second control space is made possible.

In this case, a sum of the second leakage and of the third leakage is at least as large as the first leakage. Moreover, the sum of the second leakage and of the third leakage is so small that, with the nozzle needle open, a pressure rise in the second control space brought about by the second leakage and the third leakage does not lead to closure of the nozzle needle. Advantageously, the second leakage and the third leakage prevent the first leakage from causing the nozzle needle to open inadvertently. The second and the third leakage also advantageously prevent unwanted opening of the nozzle needle in the event of very steep pressure rises in the high-pressure region.

Preferably, the piezo injector has a high-pressure bore which is connected to the high-pressure region. In this case, the high-pressure region is connected to the spring space. Advantageously, the high pressure of the high-pressure bore then constantly prevails in the spring space.

It is expedient that the spring space has arranged in it a control piston spring which acts on the control piston with a force acting in the direction of the first control space. Advantageously, the control piston spring causes the control piston to return into its initial position after an injection operation has been terminated.

It is likewise expedient that the piezo injector has a nozzle spring which acts upon the nozzle needle with a force directed away from the second control space. Advantageously, the nozzle spring then assists closure of the nozzle needle in order to terminate an injection operation.

In one embodiment of the piezo injector, there is between the leakage pin and the leakage pin bore a first pairing play which makes the first leakage possible. In this case, the first pairing play amounts to less than 2 μm. Advantageously, experiments and model computations have shown that such a first pairing play leads to a sufficiently small first leakage.

In one embodiment of the piezo injector, there is between the nozzle needle and the nozzle needle sleeve a third pairing play which makes the third leakage possible. In this case, the third pairing play amounts to between 5 μm and 8 μm. Advantageously, it has been shown in model computations and experiments that a third pairing play of this order of magnitude leads to a suitable third leakage.

In one embodiment of the piezo injector, there is between the control piston and the control piston bore a second pairing play which makes the second leakage possible. In this case, the second pairing play amounts to between 5 μm and 8 μm. Advantageously, model computations and experiments have shown that a second pairing play having such dimensioning leads to a second leakage of suitable size.

In another embodiment of a piezo injector, the control piston has a throttle bore which runs between the first control space and the spring space and which makes the second leakage possible. Advantageously, such a throttle bore also makes a second leakage of suitable size possible.

In some embodiments, the throttle bore is closed by the leakage pin when the leakage pin bears against the control piston. Advantageously, the second leakage is then interrupted when the nozzle needle is in the open state, with the result that the risk of undesirable closure of the nozzle needle brought about by the second leakage is reduced.

In one embodiment of the piezo injector, a throttle is arranged in the connecting bore between the first control space and the second control space.

In some embodiments, the piezo actuator is a fully active piezo stack. Advantageously, the piezo actuator can be separated hermetically from the fuel and therefore does not have to have special fuel resistance.

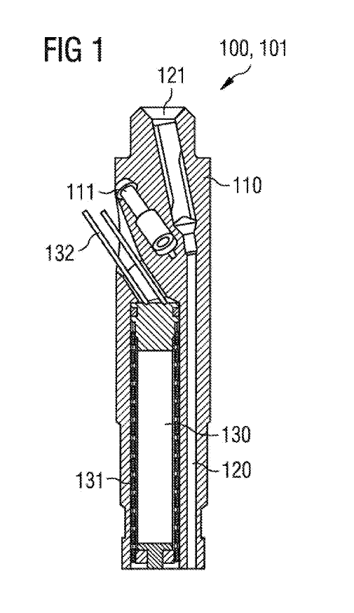

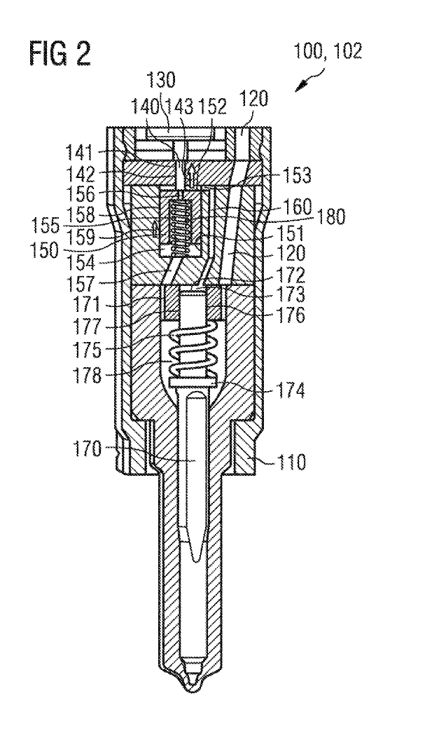

A sectional view of a piezo injector 100 is illustrated in FIGS. 1 and 2. FIG. 1 shows an upper part 101 of the piezo injector 100. FIG. 2 shows a lower part 102 of the piezo injector 100. The piezo injector 100 can serve for injecting fuel in an internal combustion engine. The piezo injector 100 can serve, for example, for injecting diesel fuel in a common rail internal combustion engine.

The piezo injector 100 has an injector housing 110. The injector housing 110 may be composed of essentially any material, since the thermal expansion properties of the injector housing 110 are unimportant. In particular, the injector housing 110 does not have to be composed of Invar.

In the injector housing 110, a high-pressure bore 120 is arranged, to which fuel which is under high pressure can be delivered via a high-pressure connection 121. The high-pressure bore 120 runs in the longitudinal direction through the injector housing 110 as far as a high-pressure region 178, also dealt with below, in the lower part 102 of the piezo injector 100. The upper part 101 of the piezo injector 100 has, furthermore, a leakage connection 111.

Further, the injector housing 110 has in the upper part 101 of the piezo injector 100 an actuator space 131 in which a piezo actuator 130 is arranged. The piezo actuator 130 is preferably a fully active piezo stack. The piezo actuator 130 has approximately a cylindrical shape and can be acted upon via an electrical connection 132 with electrical voltage in order to change the length of the piezo actuator 130 in the longitudinal direction.

The piezo injector 100 has in the lower part 102 a control piston bore 151 in which a control piston 150 is arranged. The control piston 150 has a first end face 152 pointing in the direction of the piezo actuator 130. A portion, delimited by the first end face 152, of the control piston bore 151 forms a first control space 153. The control piston bore 151 forms at its longitudinal end opposite the first control space 153 a spring space 154. The control piston 150 is thus arranged between the first control space 153 and the spring space 154.

Located in the spring space 154 is a control piston spring 155 which may be designed, for example, as a helical compression spring. A first longitudinal end of the control piston spring 155 is supported on the control piston 150. A second longitudinal end of the control piston spring 155 is supported on an end face of the control piston bore 151. The control piston spring 155 acts upon the control piston 150 with a force acting in the direction of the first control space 153.

The spring space 154 is connected to the high-pressure region 178 via a high-pressure connection 157. Thus, when the piezo injector 100 is operation, fuel having the pressure prevailing in the high-pressure bore 120 and in the high-pressure region 178 is constantly present in the spring space 154.

A leakage pin 140 is arranged in a leakage pin bore 141 between the piezo actuator 130 and the control piston bore 151. The length of the leakage pin 140 is in this case dimensioned such that an increase in the length of the piezo actuator 130 is transmitted to the control piston 150 via the leakage pin 140.

Further, the high-pressure region 178, into which the high-pressure bore 120 issues, is arranged in the lower part 102 of the piezo actuator 100. A nozzle needle 170 which guides a nozzle needle sleeve 171 is arranged in the high-pressure region 178. One longitudinal end of the nozzle needle 170, said longitudinal end pointing in the direction of the upper part 101 of the piezo injector 100, has a second end face 172. Above the second end face 172 is formed a second control space 173 which is delimited by the second end face 172 and by the nozzle needle sleeve 171. The second control space 173 is connected to the first control space 153 via a connecting bore 160.

The nozzle needle 170 has a peripheral collar 174 connected fixedly to the nozzle needle 170. Between the collar 174 and the nozzle needle sleeve 171 is arranged a nozzle spring 175 which may be designed, for example, as a helical compression spring. A first longitudinal end of the nozzle spring 175 is supported on the nozzle needle sleeve 171. A second longitudinal end of the nozzle spring 175 is supported on the collar 174. The nozzle spring 175 acts upon the nozzle needle 170 with a force directed away from the second control space 173.

When the piezo injector 100 is in the closed state, the nozzle needle 170 bears against a lower tip of the lower part 102 of the piezo injector 100. The piezo actuator 130 is discharged and has its minimum length. The piezo injector 100 does not carry out any fuel injection.

When the piezo actuator 130 is charged via the electrical connection 132 and the length of the piezo actuator 130 is thereby increased, the piezo actuator 130 exerts via the leakage pin 140 upon the control piston 150 a force by which the control piston 150 is moved in the control piston bore 151 in the direction of the spring space 154. The volume of the first control space 153 is thereby increased, with the result that the pressure in the first control space 153 and in the second control space 173 decreases. The reduced pressure in the second control space 173 therefore exerts a then reduced force upon the second end face 172 of the nozzle needle 170.

The high pressure, still acting upon the lower end of the nozzle needle 170, of the high-pressure region 178 consequently causes an upward movement of the nozzle needle 170 in the direction of the second control space 173. The piezo injector 100 is thereby opened in order to inject fuel.

The ratio of the diameter of the control piston 150 and consequently of the diameter of the first control space 153 to the diameter of the nozzle needle 170 on its second end face 172 and consequently to the diameter of the second control space 173 defines a step-up ratio between a length change of the piezo actuator 130 and a stroke of the nozzle needle 170. If the diameter of the control piston 150 amounts, for example, to 5 mm and the diameter of the nozzle needle 170 on its second end face 172 amounts, for example, to 3.5 mm, a step-up ratio of about 2 is obtained.

After the opening of the nozzle needle 170, the stroke of the nozzle needle 170 can be controlled via a variation in the length of the piezo actuator 130. The length of the piezo actuator 130 can be varied, in turn, via a variation in the energy delivered to the piezo actuator 130 via the electrical connection 132.

When the piezo actuator 130 subsequently is discharged, and therefore shortened, the high pressure prevailing in the spring space 154 and the force exerted upon the control piston 150 by the control piston spring 155 cause a movement of the control piston 150 in the direction of the first control space 153. The pressure in the first control space 153 thereby rises and, because of the connecting bore 160 present between the first control space 153 and second control space 173, the pressure in the second control space 173 also rises. This results in a movement of the nozzle needle 170 back to the lower end of the lower part 102 of the piezo injector 100, as a result of which the piezo injector 100 is closed and fuel injection is terminated.

The spring force exerted upon the control piston 150 by the control piston spring 155 ensures that, when the piezo injector 100 is in the closed state, the control piston 150 constantly bears against the leakage pin 140 and the drive formed by the piezo actuator 130, leakage pin 140 and control piston 150 is always play-free. The result of this is that varying thermal boundary conditions, length changes of the piezo actuator 130 and wear phenomena in the contact regions have no appreciable influence upon the injection quantities dispensed by the piezo injector 100.

The leakage pin 140 is fitted into the leakage pin bore 141 with a first pairing play 142. On account of the first pairing play 142, a first leakage 143 out of the first control space 143 takes place along the leakage pin 140 into a region of the piezo injector 100 which is arranged above the leakage pin 140 and from where the first leakage 143 can escape via the leakage connection 111. On account of the high pressure prevailing in the first control space 153, the first pairing play 142 selected must be small in order to obtain a small first leakage 143. The first pairing play 142 preferably amounts to less than 2 μm, especially preferably to approximately 1 μm.

The control piston 150 is fitted into the control piston bore 151 with a second pairing play 158. When the pressure in the first control space 153 is lower than the pressure in the spring space 154, a second leakage 159 from the spring space 154 along the control piston 150 into the first control space 153 occurs because of the second pairing play 158. The control piston 150 may also have a throttle bore 156 which runs from the spring space 154 through the control piston 150 to the first control space 153. In this case, a fourth leakage 180 from the spring space 154 into the first control space 153 is possible through the throttle bore 156. If the throttle bore 156 is absent, the second pairing play 158 preferably amounts to between 3 μm and 10 μm, especially preferably to between 5 μm and 8 μm, in order to make a sufficient second leakage 159 possible. If the throttle bore 156 is present and therefore the fourth leakage 180 is made possible, the second pairing play 158 selected can be very small and amount, for example, to 1 μm.

The nozzle needle 170 is fitted into the nozzle needle sleeve 171 with a third pairing play 176. When the pressure in the second control space 173 is lower than the pressure in the high-pressure region 178, a third leakage 177 out of the high-pressure region 178 into the second control space 173 can occur along the nozzle spring 175 as a result of the third pairing play 176. The third pairing play 176 preferably amounts to between 3 μm and 10 μm, especially preferably to between 5 μm and 8 μm. If the throttle bore 156 is present, the third leakage 177 may be dispensed with and the third pairing play 176 may likewise be made very small, for example of a size of about 1 μm.

When the piezo injector 100 is in the closed state, the first leakage 143 along the leakage pin 140 causes fuel to flow out of the first control space 153. So that this outflow of fuel from the first control space 153 does not lead to a pressure drop in the first control space 153, the result of which would be an inadvertent opening of the nozzle needle 170, the fuel loss caused by the first leakage 143 must be compensated by the second leakage 159, the third leakage 177 and/or the fourth leakage 180. If the throttle bore 156 is absent and therefore the fourth leakage 180 does not take place, the sum of the second leakage 159 and of the third leakage 177 must be at least as large as the first leakage 143. If the throttle bore 156 is present, the sum of the second leakage 159, of the third leakage 177 and of the fourth leakage 180 must be at least as large as the first leakage 143.

When the nozzle spring 175 and therefore the piezo injector 100 are in the open state, an inflow of fuel into the first control space 153 and the second control space 173 occurs due to the second leakage 159, the third leakage 177 and/or the fourth leakage 180. The inflow of fuel causes a pressure rise in the first control space 153 and in the second control space 173. However, the pressure increase must be so small that there is no inadvertent premature closure of the nozzle needle 170 and therefore of the piezo injector 100.

Especially preferably, the nozzle bore 156 and the leakage pin 130 are designed such that the leakage pin 140 closes the throttle bore 156 when the nozzle needle 170 is opened. As a result, with the nozzle needle 170 open, the fourth leakage 180 is prevented, so that premature undesirable closure of the nozzle needle 170 is ruled out.

A throttle may be arranged in the connecting bore 160 between the first control space 153 and the second control space 173.

The second leakage 159 and the third leakage 177 are also necessary in order to prevent unwanted opening of the nozzle needle 170 in the event of very steep pressure rises in the high-pressure region 178.

What is claimed is:

1. A piezo injector, comprising:
an actuator space in which a piezo actuator is arranged,
a control piston bore in which a control piston is arranged,
the control piston having a first end face confronting the piezo actuator,
wherein a portion of the control piston bore defined by the first end face forms a first control space,
wherein a portion of the control piston bore opposite the first control space, forms a spring space,
wherein the control piston is arranged between the first control space and the spring space,
a nozzle needle with a second end face, the nozzle needle configured to guide a nozzle needle sleeve,
wherein the nozzle needle sleeve and the second end face define a second control space,
a connecting bore between the first control space and the second control space, and
a leakage pin arranged between the piezo actuator and the first end face in a leakage pin bore.

2. The piezo injector of claim 1, wherein the piezo injector defines a structure enabling:
a first leakage out of the first control space,
a second leakage out of the spring space into the first control space, and
a third leakage out of a high-pressure region into the second control space,
wherein a sum of the second leakage and the third leakage is at least as large as the first leakage, and
wherein the sum of the second leakage and the third leakage is sufficiently small such that, with the nozzle needle open, a pressure rise in the second control space caused by the second leakage and the third leakage does not lead to closure of the nozzle needle.

3. The piezo injector of claim 1, comprising:
a high-pressure bore,
the high-pressure bore being connected to the high-pressure region,
the high-pressure region being connected to the spring space.

4. The piezo injector of claim 1, comprising a control piston spring arranged in the spring space and configured to act upon the control piston with a force acting in the direction of the first control space.

5. The piezo injector of claim 1, comprising a nozzle spring that acts upon the nozzle needle with a force directed away from the second control space.

6. The piezo injector of claim 1, comprising:
a first pairing play between the leakage pin and the leakage pin bore, the first pairing play enabling the first leakage,
wherein the first pairing play has a dimension of less than 2 μm.

7. The piezo injector of claim 1, comprising:
a third pairing play between the nozzle needle and the nozzle needle sleeve, the third pairing play enabling the third leakage, and
wherein the third pairing play has a dimension of between 5 μm and 8 μm.

8. The piezo injector of claim 1, comprising:
a second pairing play between the control piston and the control piston bore, the second pairing play enabling the second leakage, and
wherein the second pairing play has a dimension of between 5 μm and 8 μm.

9. The piezo injector of claim 1, wherein:
the control piston has a throttle bore running between the first control space and the spring space, and
the throttle bore enables the second leakage.

10. The piezo injector of claim 9, wherein the throttle bore is closed by the leakage pin when the leakage pin bears against the control piston.

11. The piezo injector of claim 1, comprising a throttle arranged in the connecting bore between the first control space and the second control space.

12. The piezo injector of claim 1, wherein the piezo actuator is a fully active piezo stack.

13. An engine, including:
common rail fule delivery system including a plurality of piezo injectors, each piezo injector comprising:
an actuator space in which a piezo actuator is arranged,
a control piston bore in which a control piston is arranged,
the control piston having a first end face confronting the piezo actuator,
wherein a portion of the control piston bore defined by the first end face forms a first control space,
wherein a portion of the control piston bore opposite the first control space, forms a spring space,
wherein the control piston is arranged between the first control space and the spring space,
a nozzle needle with a second end face, the nozzle needle configured to guide a nozzle needle sleeve,
wherein the nozzle needle sleeve and the second end face define a second control space,
a connecting bore between the first control space and the second control space, and
a leakage pin arranged between the piezo actuator and the first end face in a leakage pin bore.

14. The engine of claim 13, wherein each piezo injector defines a structure enabling:
a first leakage out of the first control space,
a second leakage out of the spring space into the first control space, and
a third leakage out of a high-pressure region into the second control space,
wherein a sum of the second leakage and the third leakage is at least as large as the first leakage, and
wherein the sum of the second leakage and the third leakage is sufficiently small such that, with the nozzle needle open, a pressure rise in the second control space caused by the second leakage and the third leakage does not lead to closure of the nozzle needle.

15. The engine of claim 13, wherein each piezo injector comprises:
a high-pressure bore,
the high-pressure bore being connected to the high-pressure region,
the high-pressure region being connected to the spring space.

16. The engine of claim 13, wherein each piezo injector comprises a control piston spring arranged in the spring space and configured to act upon the control piston with a force acting in the direction of the first control space.

17. The engine of claim 13, wherein each piezo injector comprises a nozzle spring that acts upon the nozzle needle with a force directed away from the second control space.

18. The engine of claim 13, wherein each piezo injector comprises:
a first pairing play between the leakage pin and the leakage pin bore, the first pairing play enabling the first leakage,
wherein the first pairing play has a dimension of less than 2 μm.

19. The engine of claim 13, wherein each piezo injector comprises:
a third pairing play between the nozzle needle and the nozzle needle sleeve, the third pairing play enabling the third leakage, and
wherein the third pairing play has a dimension of between 5 μm and 8 μm.

20. The engine of claim 13, wherein each piezo injector comprises:
a second pairing play between the control piston and the control piston bore, the second pairing play enabling the second leakage, and
wherein the second pairing play has a dimension of between 5 μm and 8 μm.
